(19) United States
(12) Patent Application Publication
(10) Pub. No.: US 2005/0012939 A1
(43) Pub. Date: Jan. 20, 2005

(54) Method and apparatus for quantifying the degree of fusion of a layer

(76) Inventors: Donald M. Snyder, Saline, MI (US); Naveen Raju, Ypsilanti, MI (US)

Correspondence Address: ARMSTRONG WORLD INDUSTRIES, INC.;LEGAL DEPARTMENT, P. O. BOX 3001, LANCASTER, PA, 17604-3001, US

(21) Appl. No.: 10/620,189

(22) Filed: Jul. 15, 2003

(51) Int. Cl. G01N 21/55; G01B 11/06

(52) U.S. Cl. 356/632

(57) ABSTRACT

Disclosed is a method and apparatus of monitoring and controlling the degree of fusion of a coating applied to a substrate. Fusion is determined by the measured optical distortions of laser beam reflected from the surface of the coated substrate. Optical distortion may be measured in the form of wavefront or intensity distortions. Typically, poor fusion is associated with greater distortion values.

### TECHNICAL HELD

The present invention relates to a method and apparatus for quantifying the degree of fusion in a layer, including a layer coated on a substrate and in particular the invention relates to quantifying the degree of fusion using a measured optical distortion of a laser beam.

### BACKGROUND

The use of PVC plastisol compositions in resilient sheet flooring requires careful control of heating conditions during the manufacturing process. When a coating of an unfilled PVC plastisol is fused, the heterogeneous mixture of solid PVC particles dispersed in liquid plasticizer is converted into a homogeneous, transparent solid film. During the heating, the PVC particles absorb plasticizer, soften, swell and begin to merge together, whereby the phase boundaries between the original particles become less and less distinct. As plasticizer liquid continues to diffuse through the structure, the polymer chains diffuse together and become entangled to such an extent that the original particle boundaries disappear and a homogeneous solid results.

Complete fusion of the plastisol is critical to development of optimum physical properties of the final polymer structure. For PVC-based coatings in floor applications, performance characteristic such as gloss retention, stain resistance, and overall abrasion resistance are all critically dependant on proper degree of fusion.

At present, the only method of monitoring the physical properties of the sheet flooring during manufacture requires cutting samples from the finished product at regular intervals and subjecting them to specific test procedures. Such methods are time-consuming and not adequate to address variations in oven conditions at shorter time scales than the sampling interval. These methods are not conducive to controlling process conditions in a continuous process.

Thus, a real-time, on-line method of monitoring the degree of fusion coatings during the manufacture of resilient sheet flooring is needed. Such a method is needed to enable oven temperature/line speed parameters to be kept within a defined process window to minimize scrap and long-term problems related to inadequately-fused product. Additionally, what is needed is a method for adjusting the temperature, line speed, or other processing variables in a close loop, continuous process.

### SUMMARY

The present invention comprises both a method and apparatus for quantifying the degree of fusion in a layer, including a layer coated on a substrate. The coated substrate may be a resilient sheet flooring product having a fused plastisol coating. The degree of fusion is measured by determining the optical distortions in a laser beam reflected off the coated substrate. Additionally, the method and apparatus can determine the degree of fusion of powder coatings, or any other type coating whose fusion or curing results is a change in surface smoothness or texture characteristics.

In greater detail, the method of quantifying the degree of fusion in a layer coated on a substrate includes illuminating the layer-coated substrate at some angle with a laser to produce a reflected laser beam. The reflected laser beam is then acquired or observed. Once the reflected laser beam is acquired, the reflected characteristics can be determined and the amount of distortion quantified. The optical distortion of the reflected beam induced by the layer coated on the substrate can be correlated to the degree of fusion.

In an embodiment, the method includes determining the initial characteristics of the laser beam including an initial wavefront and the characteristics of the reflected laser beam including a reflected wavefront. The degree of fusion of the layer on the coated substrate is determined by comparing the initial wavefront to the reflected wavefront to determine the wavefront distortion. The degree of wavefront distortion correlates to the degree of fusion in the coated layer.

A further embodiment includes determining the intensity profile of the reflected laser beam. The degree of fusion in the coated layer can be determined by comparing the reflected intensity profile to a set of intensity profile values corresponding to a known set of fusion values. One such intensity profile value is total intensity or power. The method may be performed in a continuous process as the coated substrate is manufactured, although non-continuous processes also are encompassed by the present invention.

Sensitivity of the measurement is increased by the use of the collimated laser beam with its characteristic highly uniform wavefront. Sensitivity of the measurement is further enhanced by the characteristically narrow operating wavelength of the single-mode laser beam.

An additional embodiment includes an apparatus for quantifying a degree of fusion in a coated substrate. The apparatus includes a laser projecting an initial laser beam onto the coated substrate and a sensor for receiving the beam reflected off the substrate. The sensor can be either a wavefront-sensitive sensor or an intensity profile sensitive sensor. Additionally, a computer is connected to the sensor for determining the degree of fusion in the layer coated on the substrate.

A further embodiment includes a method of controlling the degree of fusion of a plastisol layer comprising reflecting a laser beam off a plastisol coated substrate to produce a reflected laser beam. The reflected laser beam is then acquired and a reflected characteristic of the reflected laser beam is determined. The determined reflected characteristic is then compared with a target minimum fusion value. The fusing process can then be adjusted to conditions yielding the target minimum fusion value.

For example, if the plastisol is not adequately fused, the line speed can be slowed (dwell time increased) and/or oven temperature increased until the target value is achieved. The target value can be determined by making several samples at different process conditions, measuring an important physical property, selecting the desired physical property value, and correlating this property value with the reflective characteristic of the coated substrate having the desired property value. This technique is not limited to only plastisols but it can be applied to other materials and processes that produce different surface reflective characteristics verses processing conditions.

These and other features of the present invention will become apparent upon reading the following specification.

### DRAWINGS

In the Drawings:

FIG. 1 is a schematic illustration of the apparatus for measuring the fusion of a layer coated on a substrate, including a laser generator, a sensor and a computer;

FIG. 2 is a graph of the fusion temperature versus the average peak-to-valley (PV) value for a typical PVC plastisol formulation;

FIG. 3 is a graph of the fusion temperature versus the average root-mean-square (RMS) value for a typical PVC plastisol formulation; and

FIG. 4 is a graph of the fusion temperature versus the reflected beam power or total intensity for a typical PVC plastisol formulation.

### DETAILED DESCRIPTION

The present invention provides for both a method and apparatus of monitoring the degree of fusion of a coating 10 applied to a substrate 12. Fusion is determined by the measured optical distortions of a laser beam 6 reflected from the surface of the coated substrate 18. Optical distortion may be measured in the form of wavefront or intensity profile distortions. Typically, poor fusion is associated with greater distortion values.

The coating 10 that is applied to the substrate 12 may be an unfilled PVC plastisol composition or other polymeric material. The term “unfilled” relates to the lack of light blocking additives such as pigments and other fillers. The coating 10 forms a first layer. In another embodiment the coating 10 may be filled or opaque, such that the only limitation being that an optical distortion can be determined in the reflected beam.

The coating 10 may be formed of most any plastisol, organosol, or melt processed vinyl resin material. For example, the plastisol or organosol may be a thermoplastic polymer or homopolymer of polyvinyl chloride or other polymerizable resin, a copolymer of polyvinyl chloride and one or more other co-polymerizable resins, a block polymer of polyvinyl chloride and one or more other co-polymerizable resins, a graft polymer of polyvinyl chloride and one or more other co-polymerizable resins. Additionally, an acrylic resin capable of being dispersed into a plastisol may be included in the resin.

Melt processable materials can include homopolymers or copolymers of polyvinyl chloride, a polyamide, a polyester, polyolefins such as ethylene, propylene or polystyrene, a polycarbonate, and an acrylic. This technique is also applicable for determining the degree of fusion of powder coatings, or any other type coating whose fusion or curing results is a change in surface smoothness or texture characteristics.

Furthermore, the coating 10 that is applied to the substrate 12 may be formed of most any material wherein a degree of fusion or cure creates a different surface texture such as smoothness or roughness on the exposed surface of the coating 10. Additionally, powdered coating are also contemplated as a material for the coating 10.

The substrate 12 forms a second layer of the coated substrate 18 and can be formed of most any material. Typically, the substrate 12 can be formed of a vinyl blend comprising a free-flowing homogeneous mixture of a thermoplastic vinyl resin, vinyl plasticizers, fillers, pigments, and a vinyl stabilizer. The fillers are typically inorganic matter and may include limestone, silica, diatomaceous earth, clay and mixtures thereof. The coated substrate may have two or more layers.

Wavefront Measurement

A collimated laser beam is characterized by a well-defined planar wavefront perpendicular to the propagation vector of the beam. When such a beam is incident at an angle onto a transparent solid, such as the coating 10, a portion of the beam is reflected off the surface at the same angle. As long as the material, whether transparent or opaque, is homogeneous, the reflected beam should retain the same planar wavefront. However, if the material contains discontinuities such as regions of different refractive index, the wavefront of the reflected beam will become distorted. In the early stages of the fusion, where the phase boundaries are still pronounced, the wavefront of the reflected beam 8 is found to be strongly affected, but as the fusion progresses and the phase discontinuities become subtler, the degree of wavefront distortion also decreases.

In the wavefront embodiment, the method of quantifying a degree of fusion in the coated layer 10 includes determining an initial characteristic of the laser beam. Such a determination may be made experimentally or by a reference material. The initial characteristic of the laser beam 6 includes an initial wavefront of the laser beam as the beam is emitted from the laser generator 2 and strikes the coated substrate 18. The reflected laser beam 8 has a reflected characteristic including a reflected wavefront. Generally, the greater the shift in the wavefront the less complete the fusion in the coating 10.

Generally, there is a relationship between the fusion temperature and the degree of fusion for PVC plastisols or other coating materials. For PVC plastisols, the temperature and dwell time at the temperature determine whether it is acceptably fused. Acceptable fusion typically results in essentially achieving the highest gloss and maximum physical properties. This can be determined off-line and is used as a standard for on-line measurement and control. At this point, the surface of the fused coating will achieve a specific surface characteristic that can be measured.

Intensity Measurement

Certain intensity profile characteristics of a laser beam reflected from the surface of a fused PVC plastisol film 10 applied over a representative sample of sheet flooring substrate 12 are also strongly influenced by the degree of fusion of the plastisol. An independent correlation, which can be presented in a table format, can be established between the degree of fusion of the PVC plastisol film of actual flooring samples and the outputs of the optical sensors in order to determine if material coming off the production line has been fused to the extent required.

The intensity profile embodiment includes quantifying a degree of fusion in a layer 10 coated on the substrate 12 by reflecting the laser beam 6 off of the coated substrate 18 to produce a reflected laser beam 8, acquiring the reflected laser beam, and determining a reflected intensity profile of the reflected laser beam 8. The method further includes providing a table of beam intensity profile values having corresponding degrees of fusion in the layer coated on the substrate 18. The table can be determined experimentally such that for various measured intensity profiles, the corresponding degree of fusion can be measured. The table can be provided for a specific coated substrate 18. Furthermore, the present process can be continuous, such that as the coated substrate 18 is manufactured, the quantified degree of fusion can be determined continuously, although the invention is not limited to a continuous process.

If the plastisol composition overlies a printed or opaque substrate, reflection of the laser beam off the plastisol/substrate interface may introduce some interference and reduce the accuracy of the measurement. Therefore, it may be advantageous to measure the degree of fusion at a salvage edge of a continuous sheet product as it is being produced. Typically, the print layer of a decorative surface covering does not extend to the edge of the sheet. Further, the degree of fusion at the salvage edge is typically less than in the center of the surface covering.

Apparatus

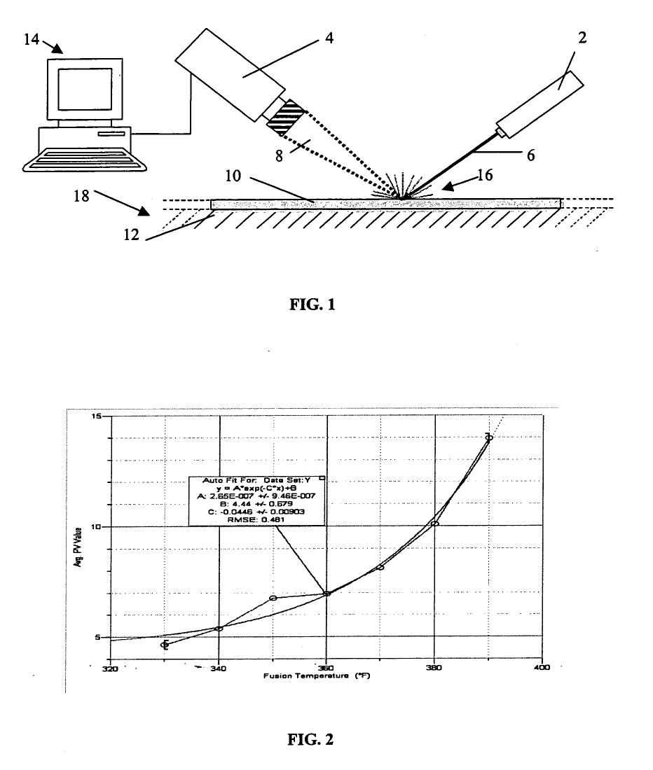

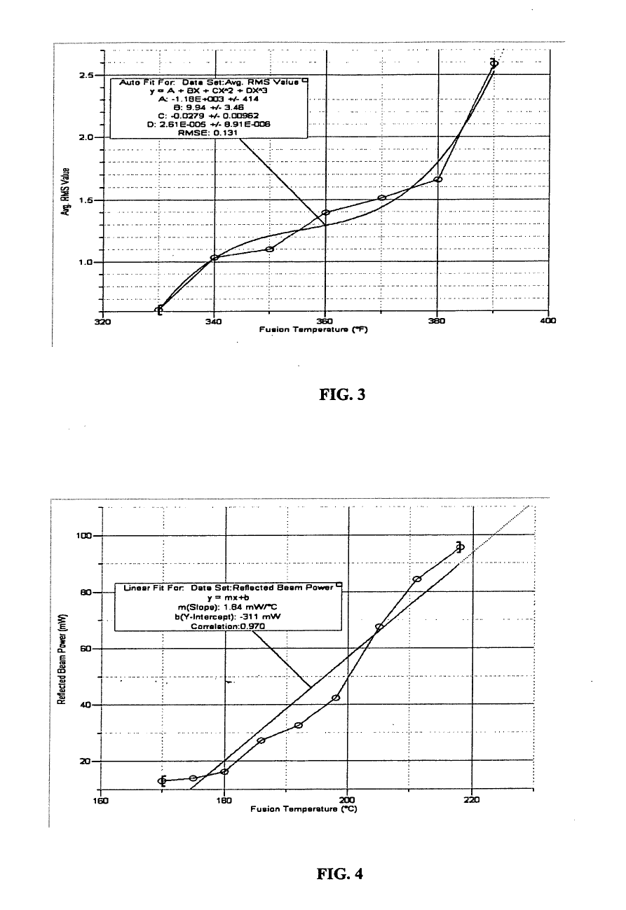

As shown in FIG. 1, a low powered laser 2 is fixed in position so that the beam is incident on the surface of the PVC plastisol composition at a fixed angle 16. The laser generator 2 is typically a fixed-power HeNe laser unit with a 5-10 mW output at 633 nm, although those skilled in the art will be aware that variable output solid-state diode lasers are available which operate at other wavelengths in the visible spectrum and that could also be utilized for this application. The incidence angle 16 measured from the surface normal is typically 45°, resulting in a total angle between the laser and detector of 90°, although the system is operable over a wide range of angles. The distance between the laser head and the target is typically in the range of 200-1000 mm but, since a HeNe laser beam has a long coherence length and minimum divergence, the exact distance is not critical and can be varied widely, depending on available space. Likewise the distance from target to detector or sensor 4 is typically 200-1000 mm but can also be varied over a considerable range.

If the reflected beam characteristics to be measured are phase-shift induced wavefront distortions, the detector 4 is a WFS-01 “WaveScope” Shack-Hartmann-type single-beam interferometer wavefront sensor system, from Adaptive Optics Associates of Cambridge, Mass. To acquire the maximum wavefront gradient data, a collimated beam expander is used to increase the incident beam diameter by a factor of approximately 10 so that the beam reflected from the larger irradiated spot completely fills the aperture of the lenslet array. The computer 14 is operatively connected to the detector 4 and contains the software to present the wavefront gradient calculations in a wide variety of formats.

A second method of quantifying the optical distortion is based on a CCD-camera type laser beam profile analyzer. This type of sensor 4 simultaneously measures the intensity distribution of the light over the entire cross-section of the beam incident on the camera aperture, so it can precisely determine the beam center-point (maximum intensity), beam shape (circular, elliptical), actual intensity distribution within the beam (versus the calculated Gaussian profile), total beam energy, and a number of other important beam parameters. An Ophir Optronics Inc. “BeamStar V” CCD-based laser beam analyzer which is designed to characterize the intensity profile of a laser over a very broad range of frequencies and power can be used to detect intensity gradients and distribution within the reflected beam. Pixel data is acquired and managed by the computer to display 2-D and 3-D plots of intensity vs. position within the beam, as well as total energy incident on the detector plane. To account for the smaller aperture of the BeamStar CCD camera, the incident beam 6 is not expanded and a small lens is placed in the path of the reflected laser beam 8 at an intermediate distance from the target spot to refocus the diverging beam into a smaller imaging spot for the camera or sensor 4.

### EXAMPLES

In the following examples, a typical PVC plastisol formulation was prepared, coated as a thin film 10 on either glass or commercial sheet flooring substrate 12, and fused for a constant time period in hot-air ovens (Mathis) at varying temperatures. The different surface morphologies at varying degrees of fusion were then studied to determine which reflected laser beam characteristics gave reproducible numerical correlations with degree of fusion.

### Example 1

Wavefront Distortion Analysis of PVC Plastisol on Glass

The PVC plastisol formulation used for testing had the following composition: 80-90 phr PVC homopolymer resin, 10-20 phr PVC homopolymer extender resin, 20-30 phr DOP-type phthalate plasticizer, 10-20 phr Texanol isobutyrate plasticizer, 3-5 phr mixed metal-salt stabilizer, 3-5 phr epoxidized soya oil, and 2-5 phr paraffinic hydrocarbon oil. After mixing, the plastisol composition was coated as a 10-20 mil film over glass microscope slides, which were then fused in a Mathis oven for 10 minutes over a range from 330-390° F. The test slides were mounted in a holder, irradiated with the HeNe laser beam and the reflected beam (90° angle) passed into the “WaveScope” sensor to acquire wavefront gradient data. Each measurement was an average of 3 images acquired at 5 second intervals, and each slide was subjected to 10-15 readings.

The operating software for the system was capable of displaying the degree of wavefront distortion in 16 different formats including: spot images, gradient vectors, optical path difference (OPD), point spread function, modulation transfer function, encircled energy, fringe plot, beam profile, beam quality, monomial, and Seidel, Hermite, Chebychev, and Zernike polynomials. Raw wavefront distortion data from the experiment was presented graphically with an OPD (Optical Path Difference Image, which can be summarized as a single value using either the PV (peak-to-valley) or RMS (root-mean-square) function. The degree of optical aberration defined by the PV value was simply the maximum recorded departure of the actual wavefront from the desired wavefront in both the positive and negative directions. The RMS wavefront error was a statistical parameter that summarized the total wavefront variance relative to the best-fit spherical wavefront (from the circular aperture).

Visible differences in the 2-D and 3-D graphical plots were readily discernible for the more complex formats, but the simplest numerical correlations with fusion temperature were found with PV and RMS values in the optical path difference format, as shown in the following Table I:

TABLE I

| Fusion Temperature (° F.) | Avg. PV Value | Avg. RMS Value |
|---|---|---|
| 330 | 4.65334 | 0.61162 |
| 340 | 5.37981 | 1.03360 |
| 350 | 6.76525 | 1.09774 |
| 360 | 6.94561 | 1.31940 |
| 370 | 8.12234 | 1.51112 |
| 380 | 10.08258 | 1.65680 |
| 390 | 13.94830 | 2.58870 |

Neither data set gave acceptable linear regression analysis statistics and both required graphical curve-fitting, indicating that the relationships of the PV and RMS values in the OPD format to degree of fusion at varying temperatures were complex. However, in both cases the steepest parts of the curves were found at the upper end of the temperature scales, indicating greatest sensitivity in the region close to complete fusion of the PVC plastisol.

### Example 2

Total Reflected Beam Intensity Analysis of PVC on Sheet Flooring Substrate

The PVC plastisol formulation specified in Example 1 was coated over a typical resilient sheet flooring composite structure and samples were then fused in a Mathis oven for 1.2 minutes at a range of temperatures of 170, 175, 180, 186, 192, 198, 205, 211 and 218° C. One inch by three inch pieces of each sample were cut and fixed onto standard glass microscope slides so that they could be mounted in the instrument holder. The unexpanded HeNe laser beam was reflected off the surface at 90°, the reflected beam intercepted by a 1-inch lens and refocused into the aperture of the “BeamStar” beam profile analyzer. The total reflected beam intensity (power in mW) was recorded for each sample, with the results shown in the following Table II:

TABLE II

| Fusion Temperature (° C.) | Total Reflected Beam Power (mW) |
|---|---|
| 170 | 12.987 |
| 175 | 13.915 |
| 180 | 16.349 |
| 186 | 27.242 |
| 192 | 32.574 |
| 198 | 42.329 |
| 205 | 67.532 |
| 211 | 84.360 |
| 218 | 95.520 |

The data set from this analytical technique showed a much more linear relationship between the measured beam parameter and the degree of fusion at varying temperatures. Linear regression statistics gave a correlation coefficient of 0.970.

In order to simulate monitoring a moving web of sheet flooring, the sample plates with the 211° C. and 218° C. fusion temperatures were removed from the holder and then remounted at random with no effort to place them in the same spots, and the reflected beam power remeasured each time for a total of 15 cycles with each sample. Statistics for this expanded data set show averages of 84.62+/−1.93 mW for the 211° C. sample and 94.58+/−2.83 mW for the 218° C. sample. These results clearly indicate that even with as small a difference in oven temperature as 7° C., a difference in surface reflectivity characteristics related to degree of fusion can be reproducibly measured.

While specification embodiments have set forth as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

1. A method of quantifying the degree of fusion of a layer comprising the following steps with no specified order, unless order is implicit in the step itself:
(a) reflecting a laser beam off the exposed surface of the layer to produce a reflected laser beam;
(b) acquiring the reflected laser beam with a sensor and determining the value of a characteristic of the reflected laser beam;
(c) determining a value based on the characteristic of the reflected beam that correlates to degree of fusion of the layer; and
(d) correlating the value based on the characteristic of the reflected beam to the degree of fusion of the layer.

2. The method of quantifying the degree of fusion of the layer of claim 1, further comprising the step (e) of determining the value of the characteristic of the laser beam reflecting the laser beam off the exposed surface of the layer having a known degree of fusion;
wherein the value based on the characteristic of the reflected beam that correlates to degree of fusion of the layer of step (c) is the value of the characteristic of the acquired reflected beam of step (b); and
wherein the step of correlating the value based on the characteristic of the reflected beam to the degree of fusion of the layer of step (d) comprises comparing:
the value based on the characteristic of the reflected beam of step (c) and
the value of the characteristic of the laser beam being reflected off the exposed surface of the layer having a known degree of fusion of step (f).

3. The method of quantifying the degree of fusion of the layer of claim 1, further comprising the step (f) of determining the value of the characteristic of the laser beam being reflected off the exposed surface of a plurality of layers having different known degrees of fusion, and plotting a graph of the known degree of fusion versus the value of the characteristic of the laser beam being reflected off the exposed surface of the layer having different known degree of fusion;
wherein the value based on the characteristic of the reflected beam that correlates to degree of fusion of the layer of step (c) is the value of the characteristic of the acquired reflected beam of step (b); and
wherein the step of correlating the value based on the characteristic of the reflected beam to the degree of fusion of the layer of step (d) comprises entering the graph with the value based on the characteristic of the reflected beam of step (c) and
determining the degree of fusion of the layer.

4. The method of quantifying the degree of fusion of the layer of claim 1, wherein the characteristic of the reflected laser beam of step (b) is the wavefront of the laser beam.

5. The method of quantifying the degree of fusion of the layer of claim 4, wherein step (d) comprises correlating the wavefront distortion to the degree of fusion of the layer.

6. The method of quantifying the degree of fusion of the layer of claim 1, wherein the characteristic of the reflected laser beam of step (b) is an intensity profile characteristic of the reflected laser beam.

7. The method of quantifying the degree of fusion of the layer of claim 6, wherein the intensity profile characteristic of the reflected laser beam is the total intensity of the reflected laser beam.

8. The method of quantifying the degree of fusion of the layer of claim 1, wherein step (d) comprises comparing the value of the characteristic of the reflected laser beam of step (b) to a set of characteristic values corresponding to a known set of fusion values.

9. The method of quantifying the degree of fusion of the layer of claim 1, wherein the layer is transparent.

10. The method of quantifying the degree of fusion of the layer of claim 1, wherein the layer is translucent or opaque.

11. The method of quantifying the degree of fusion of the layer of claim 1, wherein the method is continuous.

12. The method of quantifying the degree of fusion of the layer of claim 1, wherein the layer is a polymeric material overlying a substrate.

13. The method of quantifying the degree of fusion of the layer of claim 12, wherein the layer is transparent or translucent.

14. The method of quantifying the degree of fusion of the layer of claim 13, wherein the substrate comprises a printed pattern and an edge portion that is free of the printed pattern, and wherein the laser beam is reflected off the edge portion.

15. The method of quantifying the degree of fusion of the layer of claim 13, wherein the method is continuous.

16. An apparatus for quantifying the degree of fusion of a layer comprising:
a laser generator for projecting an initial laser beam unto the layer;
a sensor for receiving a laser beam reflected off the layer; and
a computer operatively connected to the sensor for determining the degree of fusion of the layer.

17. The apparatus for quantifying the degree of fusion of the layer of claim 16, wherein the sensor is a wavefront-sensitive sensor.

18. The apparatus for quantifying the degree of fusion of the layer of claim 17, further comprising a beam expander operatively placed between the wavefront-sensitive senor and the layer.

19. The apparatus for quantifying the degree of fusion of the layer of claim 16, wherein the sensor is an intensity profile sensitive sensor.

20. A method of controlling the degree of fusion of a polymer layer comprising:
reflecting a laser beam off the polymer layer to produce a reflected laser beam;
acquiring the reflected laser beam and determining the value of a characteristic of the reflected laser beam;
comparing the value of the determined reflected characteristic with a value corresponding to the target minimum fusion; and
adjusting the fusion processing conditions.

21. The method of claim 20, wherein the value of the target minimum fusion is determined by the steps comprising:
preparing a series of layer samples that have been fused at various temperature conditions;
determining the value of the reflected characteristics of the film samples by reflecting a laser beam off the samples to produce a reflected laser beam and determining the value of the characteristic of the reflected laser beam;
selecting a minimum desired degree of fusion of the film samples; and
selecting the corresponding reflected characteristic as a minimum target value.

22. The method of claim 21, wherein the layer comprises a polyvinyl chloride plastisol.

23. The method of claim 20, wherein the laser beam is reflected off the surface of the polymer layer near the edge of the polymer layer.
